(19) United States
(12) Patent Application Publication
(10) Pub. No.: US 2003/0088571 A1
(43) Pub. Date: May 8, 2003

(54) System and method for a peer-to peer data file service

(76) Inventor: Erik Ekkel, Cupertino, CA (US)

Correspondence Address: Corporate Patent Counsel, Philips North America Corporation, 580 White Plains Road, Tarrytown, NY, 10591, US

(21) Appl. No.: 10/006,466

(22) Filed: Nov. 8, 2001

(51) Int. Cl. G06F 7/00

(52) U.S. Cl. 707/100

(57) ABSTRACT

A system for peer-to-peer access to a collection of data is disclosed, comprising a musicbox operatively connected to a persistent data store, the persistent data store containing a plurality of data files of a predetermined data format, the data files further secured from unauthorized access; a data communication interface, operatively connected to the computer; and software executing in the computer, the software capable of identifying other systems executing the software; allowing peer-to-peer sharing of the data files with the identified other systems, the sharing restricted to the identified other systems; and allowing users of the software to manipulate the data files. In an exemplary embodiment, a plurality of data files are preloaded onto the persistent data store from a larger set of data files; access of the system to a peer-to-peer network of other like systems is initialized and the other systems available on the peer-to-peer network identified; the peer-to-peer network identifies the data files and their locations; and a user is allowed, with appropriate access rights, to catalog the data files available on the identified systems and optionally select a data file from the plurality of data files identified on the peer-to-peer network such as for sampling or downloading.

### BACKGROUND OF THE INVENTION

1. Field of the Invention

The present invention relates to the field of data file access. More specifically, the present invention, in an exemplary embodiment, relates to a system and method of operation for peer-to-peer access to data files containing data for which a royalty may be owed. More specifically still, the present invention, in an exemplary embodiment, relates to a system and method of operation for peer-to-peer access to data files to provide access to pre-loaded and dynamically loaded content from catalogs for a fee.

2. Description of the Related Art

Over the years, numerous artists and musicians have recorded great volumes of work. Numerous record companies have thousands of recordings which may not sell in great numbers. Further, shelf-space in retail environments may not allow for placing these recordings for sale as the slow-moving recording would take up valuable shelf space. As used herein, “recordings” and “content” are understood to be equivalent and comprise works subject to copyright including audiovisual works such as music, performance, film, and video; still art such as paintings; print such as text; software such as video games or other executable software; and the like. It is thus understood that, as used herein in a exemplary manner, neither “recordings” nor “content” are limited to sound recordings such as music.

The prior art has addressed delivery of content over a network such as the Internet. U.S. Pat. No. 5,726,909 to Krikorian for “CONTINUOUS PLAY BACKGROUND MUSIC SYSTEM” is illustrative. A central computer has access to a master song library, among other data files, and provides end users with access to the music from the song library. End users have appropriate equipment to render the data file into a perceptible output and can selectively customize the content to be delivered.

U.S. Pat. No. 5,918,213 issued to Bernard et al. for “SYSTEM AND METHOD FOR AUTOMATED REMOTE PREVIEWING AND PURCHASING OF MUSIC, VIDEO, SOFTWARE, AND OTHER MULTIMEDIA PRODUCTS” is further illustrative. Users of this system can make purchases via a remote communications medium without human intervention by the publisher of the work being accessed.

Neither of these prior art references discloses, suggests, or provides motivation for using a peer-to-peer network to store the data files to be made available.

Peer-to-peer sharing, as exemplified by NAPSTER, made many people aware of the power, flexibility, economics, and desirability of peer-to-peer services. See, e.g., “Music trading heads back underground” by John Borland, Staff Writer, CNET News.com May 8, 2001, available at http://news.cnet.com/news/0-1005-200-5862906.html. Some recordings may have been made available through peer-to-peer networks but such availability has often skirted the law, especially copyright law, depriving artists and their publishers such as record companies revenue they would have received if the recordings had been purchased.

Even after copyright based litigation, peer-to-peer services still draw tens of thousands of users each day. In part, these users are drawn to large numbers of recording data files still available. Many of these are works from independent labels, out-of-print and live recordings, or cultural marginalia that together still draw an audience.

Additionally, for a number of peer-to-peer software applications, search services also exist to allow finding content. For example, InfraSearch is a search engine that sends a request to other computers in the network, asking them to search their hard drives for matches to a query posed in the search. Appropriate computers may reply and pass the request along to other computers about which they are aware. See, e.g., “Peer-to-peer promises to reshape the Net” by Joshua L. Kwan, Mercury News, available at http:/www0.mercurycenter.com/svtech/news/indepth/docs/peer021201.htm

Problems with the peer-to-peer applications of the prior art remain, including reliability, redundancy coupled with ease of search, and royalties, i.e. insuring remuneration paid to the artist in an appropriate fashion.

A need therefore exists for placing recordings online and making content available in a manner that allows consumers to retrieve and purchase copies of the content in a secure environment while protecting and collecting royalties due the artists and their publishers.

### BRIEF SUMMARY OF THE INVENTION

In an exemplary embodiment, among other advantages, the present inventions provide an ability to securely distribute data that may comprise content, including back-catalog content, via a secure and controlled peer-to-peer network. The present inventions further provide for placing data online and making these data available in a manner that allows consumers to retrieve and purchase copies of the data in a secure environment while protecting and collecting royalties due the data creators and their publishers.

In an exemplary embodiment, the present inventions comprise a system for securable access to a collection of data across a peer-to-peer data network. The system may comprise a computer operatively connected to a persistent data store containing a plurality of individually selectable data files of a predetermined data format where the data files are secured from unauthorized access; a data communication interface, operatively connected to the computer to effect a peer-to-peer network; and software, executing in the computer, that is capable of identifying other systems executing instances the software, allowing peer-to-peer sharing of the data files with the identified other systems, restricting sharing of data to the identified other systems, and allowing users of the software to manipulate the data files.

The scope of protection is not limited by the summary of an exemplary embodiment set out above, but is only limited by the claims.

### BRIEF DESCRIPTION OF THE DRAWINGS

These and other features, aspects, and advantages of the present invention will become more fully apparent from the following description, appended claims, and accompanying drawings in which:

FIG. 1 is a schematic view of an exemplary system layout; and

FIG. 2 is a flowchart of an exemplary embodiment of the present system.

### DETAILED DESCRIPTION OF THE PREFERRED EMBODIMENT

By way of example and not limitation, many music companies have thousands of old song recordings which are not currently selling, e.g. a “back catalog.” Film companies may have hundreds of films which have similar sales patterns as may publishers of other works. Bringing these slow sellers to market is often an expensive proposition even though consumers exist who would be willing to purchase the work, if it were available.

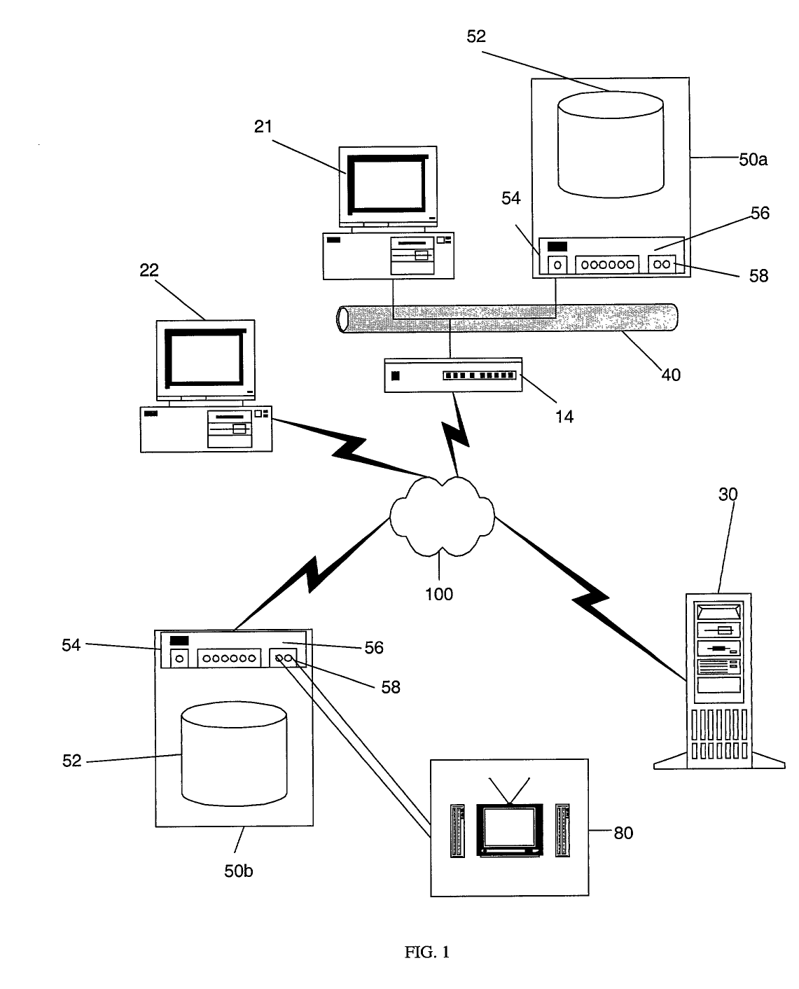

Referring now to FIG. 1, a schematic view of an exemplary system layout, in a preferred embodiment musicbox 50 comprises persistent data store 52 and data communications interface 54. Musicbox is referred to generally herein as “50” and may include musicbox 50a and 50b. Musicbox 50 may be a specialized device such as standalone musicbox 50a a or may comprise a data store 52 and requisite software 60 (not shown in the Figures) installed on one or more personal computers such as computer 21 or computer 22. In a preferred embodiment, to accommodate digital rights management (DRM), musicboxes 50 may incorporate a separate, virtual peer-to-peer network between the musicboxes 50, e.g. 50a, and 50b.

Each data store 52 may contain several tens if not hundreds of data files, including data files comprising content, by way of example and not limitation including high quality digital reproductions of music recordings, MP3 recordings, audiovisual recordings such as film, and the like, or combinations thereof. In a preferred embodiment, each data file resident on data store 52 may be secured such as with a secure data format such as AAC or other secure data formats. Additional levels of security may exist as well, such as security levels associated with each data store 52, with one or more folders on data store 52 containing data files, or the like, or a combination thereof.

In the currently preferred embodiment, data store 52 comprises a hard disk device, in a preferred embodiment having around ten gigabytes or more of data storage. Data store 52 is capable of containing around five hundred or more high quality digital audio tracks. In other currently envisioned embodiments, data store 52 may comprise any suitable large data storage device, by way of example and not limitation comprising electronic storage media, optical media such as CDROM or DVDROM, writable media optical media such as CD-R, CD-RW, and DVD-RAM, removable media, multiple media such as RAID hard disk device arrays, and the like, or combinations thereof.

In a preferred embodiment, data files may be stored using a secure format such as a DRM data structure or blanket. In this manner, if data store 52 is removed from musicbox 50 and accessed within a personal computer environment, data on data store 50 cannot be retrieved and processed into its preferred perceptible format. Additionally, data files may be stored using a database structure that comprises audio and meta-data such as lyrics, album data background information of the artists, and the like, or combinations thereof.

As will be understood by those of ordinary skill in the computer arts, data communications interface 54 may comprise a local area network adapter (not shown in the figures) such as for connection to local area network 40 or a high speed data communications device 14 or access to a high speed data communications device 14 such as a DSL router, a data communication adapter such as a DSL Internet interface, modems, serial ports, parallel ports, USB ports, FIREWIRE™ ports, or the like, or combinations thereof. A peer-to-peer network may be accomplished by access to a data network such as the Internet 100.

Standalone musicbox 50 may further comprise a controller 56 such as a central processing unit, memory, and operational software including software 60 to effect the present invention's peer-to-peer access. In alternative embodiments, controller 56 may comprise one or more application specific integrated circuits in conjunction with or in place of the central processing unit.

In a preferred embodiment, musicbox 50 may additionally have audio and/or video output connectors 58 suitable for connecting musicbox 50 to an appropriate device, e.g. an A/V receiver to allow reproduction of content on a high quality entertainment center such as 80.

Software 60 may have several components with differing capabilities. Software 60 is capable of interfacing with other musicboxes 50, including computers 21,22 executing instances of software 60, and identifying those musicboxes 50 as peers, e.g. software 60 executing in musicbox 50a might identify musicbox 50b and computer 22 as peers but not computer 21 if computer 21 was not executing software 60.

In a currently preferred embodiment, central server 30 exists to provide registration and other services. Central server 30 may reside at a data provider, at a third party site, or a combination thereof. Catalogs of data and their content may also be managed at central server 30. As central server 30 is also a peer in the peer-to-peer network, data become available almost immediately for the peer community, e.g. central server 30 may publish or broadcast a message to peers 50a, 50b, and 22 to announce that new data are available.

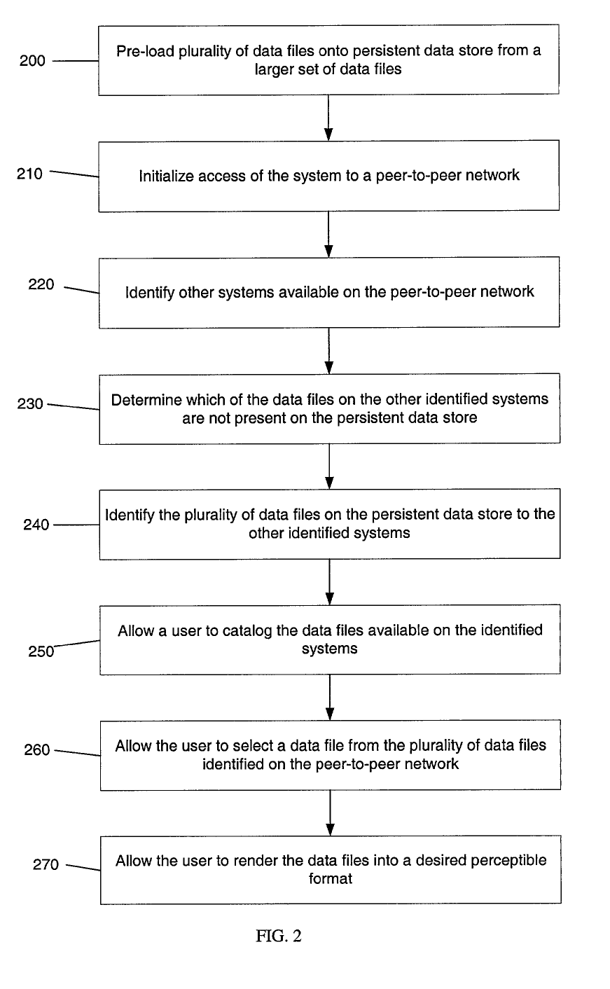

In the operation of an exemplary embodiment, referring now to FIG. 2, a flowchart of an exemplary embodiment, each data store 52 is preloaded 200 with a set of data files from a larger set of data files such as at a publisher site. The preloading may be in a predetermined or random sequence. In the preferred embodiment, overlap exists between a plurality of data stores 52 with respect to at least a portion of their data files. In this way, redundancy and availability may be enhanced once musicbox 50 is deployed onto a the peer-to-peer network.

When a musicbox 50 is initialized 210, including an appropriately configured computer with data store 52 such as computer 21, musicbox 50 participates in a the peer-to-peer network with other musicboxes 50 or computers 21,22 executing software 60. Each participant on the peer-to-peer network may identify 220 others on the peer-to-peer network via central server 30. In additionally envisioned embodiments, musicboxes 50 in systems without central server 30 may identify each other such as by going online and broadcasting within the peer-to-peer data communications network 100 to find peers, e.g. musicbox 50b pings the Internet 100 and finds musicbox 50a and computer 22. Although many equivalent methods may be employed to establish the peer-to-peer networking, as will be familiar to those of ordinary skill in the computer networking arts, one currently preferred method is described in U.S. Ser. No. 09/844,520 (attorney docket US 018052) filed Apr. 26, 2001 for Eugene Shteyn for DISTRIBUTED STORAGE ON A P2P NETWORK ARCHITECTURE, incorporated herein by reference.

Once identified, musicbox 50 may then provide 240 a catalog of data currrently on its data store 52 to other musicboxes 50 in the peer-to-peer network.

A user, e.g. at computer 21, may access 250 the totality of data files or some portion of the data files, such as through a login procedure, using techniques which will be readily familiar to those of ordinary skill in the software arts. In the preferred embodiment, the user invokes software 60 or a portion of it which presents a user interface. Using the user interface, the user may accomplish several tasks to more fully exploit the data file system. By way of example and not limitation, a user may pay a fee such as to a third party (not shown in the Figures) that allows the user to sample or otherwise access a data file or group of data files present in the peer-to-peer network comprising a musicbox 50 or a plurality of musicboxes 50.

In a currently envisioned embodiment, a consumer who wishes to use musicbox 50 buys one or more musicboxes 50 and signs-up for a subscription to the peer-to-peer network such as by telephone, web-site registration, or other means as will be familiar to those of ordinary skill in the e-commerce arts. Musicbox 50 may then be connected to the peer-to-peer network and may communicate with an authorization server such as 30 to be registered. Registration may use many appropriate means such as by a serial number.

Once registered, musicbox 50 is ‘welcomed’ into the peer-to-peer network. Additionally, registration allows data providers such as content producers or creators to collect and distribute appropriate royalties to content creators, by way of example and not limitation by having a service operator gather fees and paying the content creator or an organization such as ASCII or BMI.

In another currently envisioned embodiment, musicbox 50 may incorporate an authorization device (not shown in the Figures) such as a so-called “smart card.” The authorization device may contain one or more electronic, mechanical, or optical keys for use by musicbox 50 to unlock data stored on data store 52, e.g. for use within a DRM data structure. In a preferred embodiment, data will be preloaded such as at step 200 onto data store 52, allowing a consumer with appropriate access, e.g. the key device, to immediately access the data.

Once authorized such as via registration or with an authorization device, other musicboxes 50 in the peer-to-peer network with appropriate access rights may access the newly enabled musicbox 50 and start to download music from this new musicbox 50.

Users with subscriptions may use many methods of keeping subscriptions active, by way of example and not limitation including monthly fees, pre-paid content purchase, per unit of content purchase, and the like. In a currently envisioned alternative, users employing pre-paid content purchases may purchase and use an identifying token. The token allows the user to access the pre-paid amount of content. When the token is expended, the user may purchase a new token, e.g. the user buys a new smart card and repeats the same process. Central server 30 may be used to register the tokens.

User access can be configured such as by a login procedure and allow a user one or more of a plurality of options depending on numerous factors, by way of example and not limitation configurations provided by the artist or supplier of the data file, amount paid by the user, subscriptions enabled for the user, and the like or combinations thereof. Moreover, user access such as at step 270 may be limited to a read-only or transient access mode such as will be useful to allow access to a sampling of the recording or a view-but-do-not-permit-downloading mode of access, or permit full download of the recording for further limited or unlimited access at the user's musicbox 50 or computer, e.g. 22. By way of example and not limitation, a user may select a plurality of recordings, pay an appropriate fee, and download the recordings onto computer 22 for further processing by the user, e.g. making a custom arrangement of recordings for burning onto a CDROM. In alternatively contemplated embodiments, download to a reproducible device such as a CDROM burner may be prohibited and the peer-to-peer network restricted to a closed environment that disallows making copies, burning CDROMs, and the like.

Additionally, by way of example and not limitation, a user may use the user interface to select one or more categories of data files available from a larger set of such categories, e.g. jazz available from a set of music data files, film noir from a set of film data files, 1960s sitcoms from a set of television data files, and the like, or combinations thereof.

In further contemplated embodiments, the system of the present inventions may be personalized to a user's preferences. By way of example and not limitation, a user's downloading and listening behavior may be captured for use by musicbox 50, central server 30, or a combination thereof. Based on this prior downloading and listening behavior of the user, that user's musicbox 50 may then be loaded such as in a background process with data that fits a profile generated by such prior download and listening behavior. For example, the user's downloading and listening behavior may be processed into profiling data that is logged back to central server 30, including via a secure framework to protect the user's privacy. Those producers who operate or utilize central server 30, e.g. a record label company, may use the profiling data to determine which data are being accessed, e.g. use the profiling data to generate a rank ordering or usage pattern of the data. Such producers may further use the profile data for individualized marketing purposes, e.g. send targeted advertisements, announcement of concerts, and announcements and/or samples of new data which can be bought, and the like, or combinations thereof back to a user's musicbox 50 based on the user's profile of usage of data resident at or accessible to that musicbox 50.

Since data stored on data store 52 of a musicbox 50 is part of the peer-to-peer network, that data may be automatically sharable within the peer community. Therefore, if a user wishes to access data on other musicboxes 50, the user may use an application with a search engine that allows the user to scout for desired data. If found, the data may then be downloaded from a data store 52 on that other musicbox 50 to a data store 52 local to the user's musicbox 50. Additionally, this will mean that data may be available in multiple copies within the peer-to-peer network.

Further, a user may disable and even remove their musicbox 50 from the peer-to-peer network if they want to access the data someplace where there is no data communications connection. However, in currently envisioned embodiments, musicbox 50 may require predetermined periodic access to the peer network to remain enabled.

It will be understood that various changes in the details, materials, and arrangements of the parts which have been described and illustrated above in order to explain the nature of this invention may be made by those skilled in the art without departing from the principle and scope of the invention as recited in the following claims.

I claim:

1) A system for peer-to-peer access to a collection of data, comprising:
a. a musicbox comprising:
i. a persistent data store, the persistent data store containing a plurality of individually selectable data files of a predetermined data format, some of the data files being pre-loaded onto the persistent data store;
ii. a data communications interface operatively connected to a data communications network to effect a peer-to-peer network; and
iii. a controller operatively connected to the persisent data store and the data communications interface; and
b. software executing in the musicbox, the software capable of:
i. identifying other musicboxes executing instances of the software;
ii. allowing peer-to-peer sharing of the data files with the identified other musicboxes, the sharing restricted to the identified other musicboxes having authorization to participate in the peer-to-peer sharing of data files;
iii. securing the data files from unauthorized access;
iv. reproducing the data files into a predetermined perceptible format; and
v. allowing users of the software to manipulate the data files.

2) The system of claim 1 wherein the data files comprise works subject to copyright and workings not subject to copyright.

3) The system of claim 1 wherein the data files comprise at least one of audiovisual works, music recordings, performance recordings, digitized film recordings, digitized video recordings, graphic work images, text, and software.

4) The system of claim 1 wherein securing files from unauthorized access in step (b) (iii) comprises at least one of:
(1) securing a data file from unauthorized copying;
(2) securing a data file for authorized access;
(3) securing an predetermined collection of data files from unauthorized copying, and
(4) securing an predetermined collection of data files for authorized access.

5) The system of claim 1 further comprising an audio-visual interface to export audio and/or visual data for further reproduction of content within the data files.

6) The system of claim 1 wherein the musicbox is selected from at least one of specialized musicbox devices and personal computers.

7) The system of claim 1 further comprising a central server to provide registration services, the central server being a peer participant in the peer-to-peer network.

8) The system of claim 1 further comprising an authorization device, comprising at least one of an electronic smart card, a mechanical smart card, and an optical key smart card.

9) A method of distributing data files for a system of claim 1, comprising:
a. pre-loading a plurality of data files onto the persistent data store from a larger set of data files;
b. initializing access of the system to a peer-to-peer network;
c. identifying other systems available on the peer-to-peer network;
d. determining which of the data files on the other identified systems are not present on the persistent data store;
e. identifying the plurality of data files on the persistent data store to the other identified systems;
f. allowing a user to catalog the data files available on the identified systems;
g. allowing the user to select a data file from the plurality of data files identified on the peer-to-peer network; and
h. allowing the user to render the data files into a desired perceptible format.

10) The method of claim 9 further comprising requiring a user to log into the peer-to-peer network and presenting a user interface to the user appropriate to allow the user to select one or more categories of data files available from a larger set of such categories.

11) The method of claim 9 further comprising requiring access by the musicbox to the peer-to-peer network on a predetermined periodic basis.

12) The method of claim 9 further comprising allowing user to purchase a data file for permanent access, the permanent access comprising downloading the data file onto a storage medium of the user's choice.

13) The method of claim 9 further comprising limiting a user to at least one of a read-only or transient access mode.

14) The method of claim 9, wherein step (b) further comprises:
i. requiring the user to obtain a subscription;
ii. registering the user once the subscription is obtained; and
iii. collecting and distributing appropriate royalties to content creators at least partially based on the user's subscription.

15) The method of claim 14 wherein the subscription comprises at least one of monthly fees, pre-paid content purchase, and per unit of content purchase.

16) The method of claim 9 wherein step (b) further comprises accessing a central server to accomplish the initializing of access to the peer-to-peer network, the central server being a peer participant in the peer-to-peer network.

17) The method of claim 9 wherein step (c) further comprises at least one of identifying a musicbox to a central server, indentifying a musicbox to other participants in the peer-to-peer network by broadcasting an identity of the musicbox to the other participants in the peer-to-peer network, and indentifying a musicbox to other participants in the peer-to-peer network by pinging for an identity of the other participants in the peer-to-peer network.

18) The method of claim 9 wherein step (e) further comprises programmatically providing one or more participants in the peer-to-peer network with a description of content available at a musicbox to allow users to scout for desired content.

19) The method of claim 9 further comprising:
a. gathering data of the user's usage of the musicbox into a user data profile;
b. making the user data profile available to a content provider.

20) The method of claim 19, further comprising using the user data profile by a provider of data files to generate messages targeted to the user based where the targeted messages comprise at least one of advertisements, announcements, and samples of further data similar to that in the profile data.

21) A system for peer-to-peer access to a collection of data, comprising:
a. means for storing persistent data, the persistent data comprising a plurality of data files of a predetermined data format, the data files further secured from unauthorized access;
b. means for data communications, operatively connected to the means for storing persistent data; and
c. means for accessing the persistent data, operatively in communication with the means for storing persistent data and the means for data communications, capable of:
i. identifying other systems executing the means for accessing the persistent data;
ii. allowing peer-to-peer sharing of the persistent data with the identified other systems, the sharing restricted to the identified other systems; and
iii. allowing users of the means for accessing the persistent data to manipulate the persistent data.
